(19) United States
(12) Patent Application Publication
(10) Pub. No.: US 2014/0078592 A1
(43) Pub. Date: Mar. 20, 2014

(54) DISPLAY DEVICE

(71) Applicant: KABUSHIKI KAISHA TOSHIBA, Tokyo (JP)

(72) Inventors: Aira Hotta, Kanagawa-ken (JP); Minoru Inomoto, Kanagawa-ken (JP); Naotada Okada, Kanagawa-ken (JP); Haruhiko Okumura, Kanagawa-ken (JP); Masashi Nishiyama, Kanagawa-ken (JP); Akihisa Moriya, Kanagawa-ken (JP); Takashi Sasaki, Kanagawa-ken (JP); Tsuyoshi Tasaki, Kanagawa-ken (JP)

(73) Assignee: KABUSHIKI KAISHA TOSHIBA, Tokyo (JP)

(21) Appl. No.: 13/968,508

(22) Filed: Aug. 16, 2013

(30) Foreign Application Priority Data
Sep. 14, 2012 (JP) 2012-203426

(51) Int. Cl. G02B 27/01

(52) U.S. Cl. CPC G02B 27/0172
USPC 359/633

(57) ABSTRACT

According to one embodiment, a display device, includes an image projection unit and an optical unit. The image projection unit includes a laser beam source configured to emit a laser beam including image information, and a scanning unit configured to scan the laser beam. The optical unit includes a reflecting unit. The reflecting unit includes a plurality of half mirrors stacked with each other. The scanned laser beam is sequentially incident on the plurality of half mirrors. Respective reflected laser beams produced by being reflected by each of the half mirrors pass through a plurality of mutually-different points.

### CROSS-REFERENCE TO RELATED APPLICATIONS

This application is based upon and claims the benefit of priority from Japanese Patent Application No. 2012-203426, filed on Sep. 14, 2012; the entire contents of which are incorporated herein by reference.

### FIELD

Embodiments described herein relate generally to display device.

### BACKGROUND

Head mounted displays (HMDs) that are mounted on the head of a user have been developed such that the user can view an image. It is important to reduce the size of the device to enable practical use of such a HMD.

On the other hand, it is also important for the HMD to be easy to view. To this end, there is a method that utilizes a Maxwellian view in which focus adjustment of the lens of the eye is unnecessary. However, in the Maxwellian view, the location (the viewing zone) where it is possible to view the display image is extremely narrow. Conversely, there is a method for forming convergence points of the light at multiple positions by providing multiple pinholes in the optical system of the Maxwellian view. However, it is difficult to reduce the size of the device using such a method.

### BRIEF DESCRIPTION OF THE DRAWINGS

FIG. 1 is a schematic plan view showing a display device according to a first embodiment;

FIG. 2 is a schematic perspective view showing the display device according to the first embodiment;

FIG. 3 is a schematic plan view showing an operation of the display device according to the first embodiment;

FIG. 4 is a schematic cross-sectional view showing the display device according to the first embodiment;

FIG. 5 is a schematic view showing a portion of the display device according to the first embodiment;

FIG. 6 is a schematic plan view showing a portion of the display device according to the second embodiment;

FIG. 7 is a graph showing characteristics of the half mirror; and

FIG. 8 is a graph showing the operation of the display device according to the second embodiment.

### DETAILED DESCRIPTION

According to one embodiment, a display device, includes an image projection unit and an optical unit. The image projection unit includes a laser beam source configured to emit a laser beam including image information, and a scanning unit configured to scan the laser beam. The optical unit includes a reflecting unit. The reflecting unit includes a plurality of half mirrors stacked with each other. The scanned laser beam is sequentially incident on the plurality of half mirrors. Respective reflected laser beams produced by being reflected by each of the half mirrors pass through a plurality of mutually-different points.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

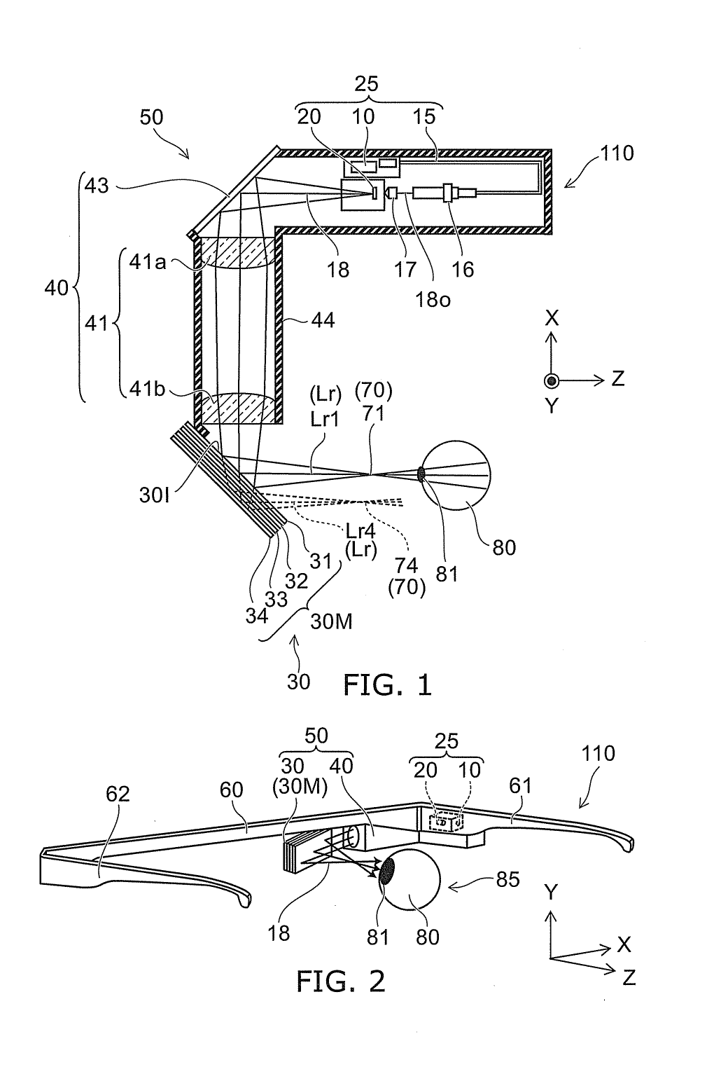

FIG. 1 is a schematic plan view illustrating the configuration of a display device according to a first embodiment

FIG. 2 is a schematic perspective view illustrating the configuration of the display device according to the first embodiment.

As shown in FIG. 2, the display device 110 according to the embodiment includes an image projection unit 25 and an optical unit 50.

The image projection unit 25 includes a laser beam source 10 and a scanning unit 20. The laser beam source 10 emits a laser beam including image information. The scanning unit 20 scans the laser beam emitted from the laser beam source 10. The scanning unit 20 scans the laser beam using a raster method. An example of the image projection unit 25 is described below.

The optical unit 50 includes a reflecting unit 30. In the example, the optical unit 50 further includes an optical element unit 40. The reflecting unit 30 includes multiple half mirrors 30M that are stacked with each other.

A scanned laser beam 18 emitted from the image projection unit 25 is incident on the multiple half mirrors 30M. The scanned laser beam 18 reflected at the multiple half mirrors 30M is incident on an eye 80 (specifically, a pupil 81) of a user 85 of the display device 110.

The user 85 views the image information included in the laser beam 18. The display device 110 is, for example, a head mounted display device. The display device 110 is, for example, a see-through monocular HMD. The user 85 views the image formed from the scanned laser beam 18 that is reflected at the reflecting unit 30, and the background image (the actual background image) that passes through the reflecting unit 30. The image that is displayed is viewed overlapping the background image.

In the example, a holder 60 is further provided. The holder 60 holds the image projection unit 25 and the optical unit 50. For example, the holder 60 includes a right-side holding member 61 designed to contact a right-side portion (e.g., proximal to the ear on the right side) of the head of the user 85, and a left-side holding member 62 designed to contact a left-side portion (e.g., proximal to the ear on the left side) of the head of the user 85. Thereby, the holder 60 regulates the spatial disposition between the optical unit 50 and the eye 80 of the user 85.

Due to the holder 60, the laser beam 18 reflected by the multiple half mirrors 30M is stably incident on the eye 80; and a stable display is possible.

In the display device 110, the travel direction of the laser beam 18 reflected by the multiple half mirrors 30M is taken as a Z-axis direction. The Z-axis direction corresponds to the travel direction of the light formed when the laser beam 18 corresponding to the central portion of the image of the scanned laser beam 18 is reflected by the half mirrors 30M. One direction perpendicular to the Z-axis direction is taken as an X-axis direction. A direction perpendicular to the Z-axis direction and the X-axis direction is taken as a Y-axis direction. The Z-axis direction is the direction from the front toward the rear as viewed by the user 85. The X-axis direction is, for example, the left and right direction. The Y-axis direction is, for example, the vertical direction.

FIG. 1 is an X-Z plan view relating to the image projection unit 25 and the optical unit 50.

As shown in FIG. 1, the image projection unit 25 further includes an optical fiber 15, a fiber guide 16, and a light source-side lens 17. The optical fiber 15 guides a laser beam 18o emitted from the laser beam source 10 toward the scanning unit 20. The laser beam 18o guided through the optical fiber 15 is emitted from the fiber guide 16. The laser beam 18o passing through the fiber guide 16 is incident on the light source-side lens 17. The light source-side lens 17 collimates the laser beam 180. For example, the light source-side lens 17 is used to adjust the focus of the image.

The laser beam 18 emitted from the light source-side lens 17 is incident on the scanning unit 20. The scanning unit 20 may include, for example, a MEMS (Micro Electro Mechanical Systems) device.

The optical element unit 40 of the optical unit 50 includes, for example, a lens unit 41, a reflective mirror 43, and a housing 44. The housing 44 holds the lens unit 41 and the reflective mirror 43. In the example, the housing 44 also holds the image projection unit 25 and the reflecting unit 30. The lens unit 41 includes a first lens 41a and a second lens 41b.

The scanned laser beam 18 emitted from the scanning unit 20 of the image projection unit 25 moves in a range of a constant angle along the direction of the scanning. The laser beam 18 is obliquely incident on the reflective mirror 43; the direction of the laser beam 18 is changed by being reflected; and the laser beam 18 is incident on the first lens 41a. The first lens 41a causes each of the scanned laser beams 18 to be substantially parallel to each other. The laser beam 18 passing through the first lens 41a is incident on the second lens 41b. The scanned laser beam 18 passing through the second lens 41b is incident on an incident surface 30I of the reflecting unit 30 while being concentrated.

The reflecting unit 30 includes the multiple half mirrors 30M which are stacked with each other. In the example, the multiple half mirrors 30M of the reflecting unit 30 include first to nth (n being an integer not less than 2) half mirrors. The ith (i being an integer less n and not less than 1) half mirror 30M; is disposed on the incident surface 30I side of the (i+1)th half mirror 30Mᵢ₊₁.

In the example, the multiple half mirrors 30M of the reflecting unit 30 include four half mirrors 30M (i.e., first to fourth half mirrors 31 to 34). The first half mirror 31, the second half mirror 32, the third half mirror 33, and the fourth half mirror 34 are stacked in this order from the incident surface 30I.

In the embodiment, the number of the multiple half mirrors 30M (i.e., n recited above) is arbitrary. An example in which n is 4 will now be described.

The scanned laser beam 18 is sequentially incident on the multiple half mirrors 30M. Multiple reflected laser beams Lr are produced by being respectively reflected by the multiple half mirrors 30M to respectively pass through multiple mutually-different points 70.

In FIG. 1, a first reflected laser beam Lr1 produced at the first half mirror 31 and a fourth reflected laser beam Lr4 produced at the fourth half mirror 34 are shown for easier viewing of the drawing. The first reflected laser beam Lr1 is produced by the scanned laser beam 18; and the first reflected laser beam Lr1 also is scanned. The scanned first reflected laser beam Lr1 passes through a first point 71. The fourth reflected laser beam Lr4 also is produced by the scanned laser beam 18; and the fourth reflected laser beam Lr4 also is scanned. The scanned fourth reflected laser beam Lr4 passes through a fourth point 74 that is different from the first point 71.

In the case of one half mirror (e.g., in the case where only the first half mirror 31 is provided), only the first reflected laser beam Lr1 that is reflected by the first half mirror 31 is produced from the scanned laser beam 18. Because the scanned first reflected laser beam Lr1 passes through the first point 71, the user 85 can view the image when the pupil 81 of the eye 80 of the user 85 is at a position where the light passing through the first point 71 is incident on the pupil 81. However, the user 85 cannot view the image in the case where the pupil 81 is distal to the position where the light passing through the first point 71 is incident. Therefore, the range (the viewing zone) where the user 85 can view the image is limited to the vicinity of the first point 71 and is narrow.

Conversely, in the embodiment, the scanned reflected laser beams Lr pass through multiple mutually-different points 70 because the multiple half mirrors 30M are provided. Therefore, the user can view the image at the vicinity of each of the multiple points 70; and the practical viewing zone enlarges. In the embodiment, the multiple half mirrors 30M increase the number of points 70 that the scanned laser beam 18 passes through (to be concentrated).

In the display device 110, the scanned laser beam 18 including the image passes through one point (e.g., one selected from the multiple points 70). In the case where the position (the position in the Z-axis direction) of the pupil 81 of the eye 80 is proximal to the point, a display is possible in which focus adjustment of the lens of the eye 80 is unnecessary. In other words, the display device 110 provides, for example, a display using a substantially Maxwellian view.

The display device 110 is a scanning laser display device that uses the laser beam source 10 and the scanning unit 20. Therefore, the device is small and lightweight.

Thus, according to the embodiment, a compact display device having a wide viewing zone that is easy to view can be provided because the focus adjustment is substantially unnecessary.

In the embodiment, the holder 60 regulates the spatial disposition between the eye 80 of the user 85 and the multiple points 70 that the scanned reflected laser beams Lr pass through. Thereby, the positional relationship between the eye 80 and the multiple points 70 is determined; and a stable display having a wide viewing zone is possible.

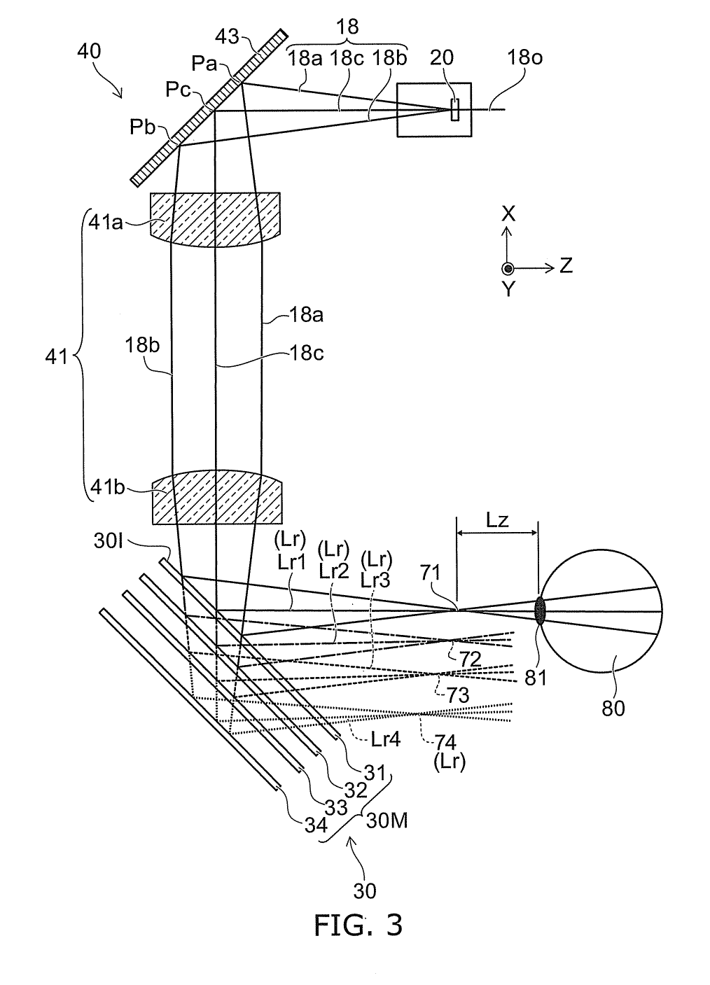

FIG. 3 is a schematic plan view illustrating an operation of the display device according to the first embodiment.

As shown in FIG. 3, the scanning unit 20 scans the laser beam 18 between a first position Pa corresponding to the one end of the image and a second position Pb corresponding to the one other end of the image. A central position Pc is disposed between the first position Pa and the second position Pb. To simplify the description in the example, positions on the reflective mirror 43 relating to the first position Pa, the second position Pb, and the central position Pc are shown. However, the first position Pa, the second position Pb, and the central position Pc may be any position in space. At a first time, the scanning unit 20 produces a first scanned laser beam 18a that is incident on the first position Pa by scanning the laser beam 18. At a second time, the scanning unit 20 produces a second scanned laser beam 18b that is incident on the second position Pb by scanning the laser beam 18. At a third time that is between the first time and the second time, the scanning unit 20 produces a third scanned laser beam 18c that is incident on the central position Pc.

The first scanned laser beam 18a and the second scanned laser beam 18b are non-parallel to each other when emitted from the scanning unit 20. The first to third scanned laser beams 18a to 18c are reflected by the reflective mirror 43 and enter the first lens 41a to become parallel to each other. When the first to third scanned laser beams 18a to 18c that are parallel pass through the second lens 41b, the first to third scanned laser beams 18a to 18c become non-parallel to each other.

The scanned laser beam 18 (the first to third scanned laser beams 18a to 18c) is sequentially incident on the multiple half mirrors 30M. In other words, the laser beam 18 is incident on the (i+1)th half mirror 30Mᵢ₊₁ after being incident on the ith half mirror 30Mᵢ.

For example, the scanned laser beam 18 is incident on the first half mirror 31. A portion of the scanned laser beam 18 that is incident on the first half mirror 31 produces the first reflected laser beam Lr1 by being reflected by the first half mirror 31.

One other portion of the scanned laser beam 18 that is incident on the first half mirror 31 is incident on the second half mirror 32 by passing through the first half mirror 31. The one other portion of the scanned laser beam 18 recited above that is incident on the second half mirror 32 produces the second reflected laser beam Lr2 by being reflected by the second half mirror 32.

Thus, the scanned laser beam 18 produces the multiple reflected laser beams Lr (e.g., the first to fourth reflected laser beams Lr1 to Lr4) by being reflected respectively by the multiple half mirrors 30M (e.g., the first to fourth half mirrors 31 to 34).

Each of the multiple reflected laser beams Lr is based on the scanned laser beam 18 (the first to third scanned laser beams 18a to 18c, etc.). For each of the multiple reflected laser beams Lr, the first to third scanned laser beams 18a to 18c pass through one point 70. The points 70 are, for example, focal points (viewpoints). In the example, the multiple reflected laser beams Lr respectively pass through the multiple points 70 (in this example, the first to fourth points 71 to 74).

The user 85 can view the image formed from the scanned laser beam 18 when the pupil 81 is positioned at positions corresponding to the multiple points 70 (the first to fourth points 71 to 74). The image can be viewed at the first to fourth points 71 to 74 or at positions proximal to the first to fourth points 71 to 74.

It is favorable for the position of the pupil 81 of the eye 80 to match the position of the point 70. In other words, it is desirable for a distance Lz between the point 70 and the pupil 81 of the eye 80 to be substantially 0 mm. For example, if the absolute value of the distance Lz is not more than 10 mm in the embodiment, a display (e.g., a substantially Maxwellian view) in which focus adjustment of the lens is unnecessary can be provided. It is favorable for the absolute value of the distance Lz between the pupil 81 and the point 70 to be, for example, not less than 0 mm and not more than 11 mm. It is more favorable for the absolute value of the distance Lz between the pupil 81 and the point 70 to be, for example, not less than 0 mm and not more than 9 mm. In other words, the absolute value of the distance Lz between the pupil 81 and the point 70 is not less than 0 mm and not more than about 10 mm.

Thus, according to the embodiment, a compact display device having a wide viewing zone that is easy to view can be provided because the focus adjustment is substantially unnecessary.

In the embodiment, the lens unit 41 including the first lens 41a and the second lens 41b is provided in the optical element unit 40. Such a lens unit 41 causes the axis of the light that moves in a range of a constant angle along the direction of the scanning to be parallel. In other words, the scanning unit 20 scans the laser beam 18 between the first position Pa corresponding to the one end of the image and the second position Pb corresponding to the one other end of the image. The lens unit 41 causes the travel direction of the laser beam 18 scanned to the first position Pa to be parallel to the travel direction of the laser beam 18 scanned to the second position Pb. Thus, by causing the travel directions of the scanned laser beam 18 to be parallel, the characteristics of the laser beam 18 that is incident on the reflecting unit 30 do not change even when the distance between the first lens 41a and the second lens 41b is modified. By providing such a lens unit 41, the design of the device is easier. The lens unit 41 is, for example, a telecentric optical system.

The focal distance of the first lens 41a is, for example, the same as the focal distance of the second lens 41b. Thereby, the laser beams 18 can be caused to be parallel. The angle of view is determined by the focal distance of the lenses. In the embodiment, the angle of view is, for example, not less than ±5 degrees and not more than ±20 degrees (e.g., ±10.3 degrees).

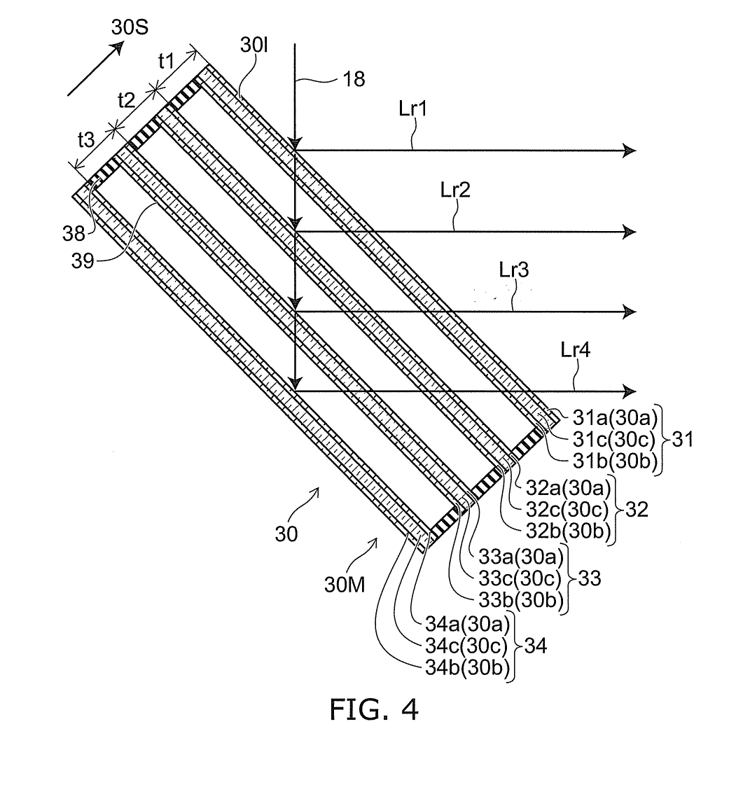

FIG. 4 is a schematic cross-sectional view illustrating the configuration of the display device according to the first embodiment.

FIG. 4 shows an example of the configuration of the reflecting unit 30.

As shown in FIG. 4, each of the multiple half mirrors 30M may include a reflective/transmissive film 30a and a reflection suppression film 30b (an antireflective film). In the example, each of the multiple half mirrors 30M further includes a substrate 30c.

The reflective/transmissive film 30a transmits a portion of the scanned laser beam 18 and reflects one other portion of the scanned laser beam 18. The reflection suppression film 30b is stacked with the reflective/transmissive film 30a. The substrate 30c is disposed between the reflective/transmissive film 30a and the reflection suppression film 30b to transmit the laser beam 18.

For example, the first half mirror 31 includes a first reflective/transmissive film 31a that transmits a portion of the scanned laser beam 18 and reflects one other portion of the scanned laser beam 18, a first reflection suppression film 31b stacked with the first reflective/transmissive film 31a, and a first substrate 31c that is disposed between the first reflective/transmissive film 31a and the first reflection suppression film 31b to transmit the laser beam 18.

The second half mirror 32 includes a second reflective/transmissive film 32a that transmits a portion of the scanned laser beam 18 and reflects one other portion of the scanned laser beam 18, a second reflection suppression film 32b stacked with the second reflective/transmissive film 32a, and a second substrate 32c that is disposed between the second reflective/transmissive film 32a and the second reflection suppression film 32b to transmit the laser beam 18.

Similarly, the third half mirror 33 includes a third reflective/transmissive film 33a, a third reflection suppression film 33b, and a third substrate 33c. The fourth half mirror 34 includes a fourth reflective/transmissive film 34a, a fourth reflection suppression film 34b, and a fourth substrate 34c.

The first to fourth reflective/transmissive films 31a to 34a recited above reflect the scanned laser beam 18; and the reflected scanned laser beams 18 pass through the first to fourth points 71 to 74, respectively.

The first to fourth reflection suppression films 31b to 34b can suppress unnecessary reflections at the back surfaces of the first to fourth substrates 31c to 34c (the surfaces on the sides opposite to the first to fourth reflective/transmissive films 31a to 34a).

The substrate includes, for example, a glass substrate, a transparent resin, etc. The length of one side of the substrate is, for example, not less than 20 mm and not more than 40 mm (e.g., 30 mm). The length of one other side of the substrate is, for example, not less than 30 mm and not more than 50 mm (e.g., 40 mm). The thickness of the substrate is, for example, not less than 0.2 mm and not more than 0.7 mm (e.g., 0.5 mm)

The reflective/transmissive film 30a includes, for example, a thin film of a metal. The metal includes, for example, at least one selected from aluminum and silver, etc. The thickness of the thin film of the metal is, for example, not less than 0.01 micrometers (μm) and not more than 0.2 μm.

The reflection suppression film 30b includes, for example, a stacked film of a metal oxide film, a stacked film of a fluoride film, a stacked film including a metal oxide film and a fluoride film, etc.

The multiple half mirrors 30M are planes. The reflective surfaces of the multiple half mirrors 30M are parallel to each other. Thereby, the laser beams 18 can pass through the multiple points 70 in a state in which the distortion and the like of the image are suppressed.

In the example, spacers 38 are provided to determine the distances between the multiple half mirrors 30M. Thereby, gap units 39 are made between the multiple half mirrors 30M. In other words, the reflecting unit 30 may further include the gap unit 39 provided between the multiple half mirrors 30M. The refractive index of the gap unit 39 is lower than the refractive index of the multiple half mirrors 30M. By providing the gap unit 39, mutually-different reflected light beams (the first to third reflected laser beams Lr1 to Lr4 recited above, etc.) are obtained using the multiple half mirrors 30M.

The gap unit 39 is, for example, an air layer. Also, a resin layer, etc., having a low refractive index may be used as the gap unit 39.

In the case where the reflective/transmissive film 30a (e.g., the first to fourth reflective/transmissive films 31a to 34a) is provided in the half mirror 30M, the reflective surface of the half mirror 30M is substantially the reflective/transmissive film 30a (e.g., the first to fourth reflective/transmissive films 31a to 34a).

The distance along a stacking direction 30s of the multiple half mirrors 30M between the reflective surface of one of two most proximal half mirrors of the multiple half mirrors 30M and the reflective surface of one other of the two most proximal half mirrors 30M of the multiple half mirrors 30M is, for example, not less than 1.3 mm and not more than 4 mm.

For example, a first distance t1 along the stacking direction 30s between the first half mirror 31 and the second half mirror 32, a second distance t2 along the stacking direction 30s between the second half mirror 32 and the third half mirror 33, and a third distance t3 along the stacking direction 30s between the third half mirror 33 and the fourth half mirror 34 are, for example, not less than 1.5 mm and not more than 4.0 mm.

For example, in the case where the laser beam 18 is incident on the incident surface 30I of the reflecting unit 30 at an incident angle of 45 degrees, the distance between the multiple points 70 is about 1.4 times the distance recited above. When the distance recited above is not less than 1.5 mm and not more than 4.0 mm, the distance between the multiple points 70 is not less than 2.1 mm and not more than 5.6 mm.

The diameter of the pupil (the pupil 81) of the eye 80 is not less than about 1.5 mm. On the other hand, the position (e.g., the position of the center) of the pupil 81 of the eye 80 moves a distance of about 5 mm according to, for example, the change of the line of sight of the user 85, etc. By the distance recited above being not less than 1.5 mm and not more than 4.0 mm, the change of the line of sight can be accommodated; and the light of a substantially Maxwellian view can be appropriately incident on the pupil.

It is more desirable for the first to third distances t1 to t3 to be, for example, not less than 2.5 mm and not more than 3.5 mm.

In the embodiment, the diameter of the laser beam (the laser beam 18o or the laser beam 18) is small. For example, the diameter of the spot of the laser beam 18 when incident on the reflecting unit 30 is not less than 100 μm and not more than 800 μm. The resolution of the image is increased by using the laser beam 18 having a small diameter.

In the embodiment, the laser beam (the laser beam 18o or the laser beam 18) is a substantially parallel beam. Thereby, a display that uses a substantially Maxwellian view can be realized by a simple optical system. The spread angle of the beam of the scanned laser beam 18 when emitted from the image projection unit 25 is, for example, not more than plus or minus 5 degrees.

The first reflected laser beam Lr1 from the first half mirror 31 does not pass through the other half mirrors 30M. Conversely, a second reflected laser beam Lr2 from the second half mirror 32 has a loss due to passing through the first half mirror 31. In the case where the reflectance of the second half mirror 32 is set to be the same as the reflectance of the first half mirror 31, the image formed of the second reflected laser beam Lr2 from the second half mirror 32 is darker than the image formed of the first reflected laser beam Lr1 from the first half mirror 31.

To compensate this, it is favorable to adjust the reflectance of each of the multiple half mirrors 30M. In other words, in the embodiment, it is favorable for the reflectance to be different between the multiple half mirrors 30M of the reflecting unit 30. For example, the reflectance of the first half mirror 31 is set to be lower than the reflectance of the second half mirror 32. Thereby, the difference between the brightness of the second reflected laser beam Lr2 from the second half mirror 32 and the brightness of the first reflected laser beam Lr1 from the first half mirror 31 can be reduced.

For example, the multiple half mirrors 30M include the first to nth (n being an integer not less than 2) half mirrors; and the ith (i being an integer less n and not less than 1) half mirror 30M; is disposed on the incident surface 30I side of the (i+1)th half mirror 30Mᵢ₊₁. In such a case, a reflectance R; of the ith half mirror 30M; is set to be lower than a reflectance Rᵢ₊₁ of the (i+1)th half mirror 30Mᵢ₊₁. Thereby, the brightness difference between the reflected laser beams Lr can be reduced.

For example, the reflectance R; of the ith half mirror 30Mᵢ, an absorptance A; of the ith half mirror 30M, and the reflectance Rᵢ₊₁ of the (i+1)th half mirror 30Mᵢ₊₁ are set such that Rᵢ₊₁ is equal to Rᵢ/Aᵢ²(1−Rᵢ). The brightness becomes the same between the reflected laser beams Lr. An error of 20% is permissible for this condition; and in such a case, it is favorable for the relationship

Rᵢ/Aᵢ²(1−Rᵢ)×0.8<Rᵢ₊₁<Rᵢ/Aᵢ²(1−Rᵢ)×1.2

to be satisfied.

Thereby, the brightness difference of the images at the multiple points 70 decreases; and an easily-viewable display is possible.

For example, a reflectance R₁ of the first half mirror 31 is 0.07. A reflectance R₂ of the second half mirror 32 is 0.082. A reflectance R₃ of the third half mirror 33 is 0.102. The reflectance R₄ of the fourth half mirror 34 is 0.147. Thereby, the intensities of the first to fourth reflected laser beams Lr1 to Lr4 from the first to fourth half mirrors 31 to 34 are substantially equal to each other.

However, one of the points 70 may be a standard viewpoint and the other points 70 may be supplemental viewpoints; and in such a case, the reflectance of each of the multiple half mirrors 30M may be set by a condition different from the formula recited above.

In the embodiment, it is favorable for the thickness of the reflective/transmissive film 30a to be not less than 100 nanometers and not more than 150 nanometers. In the case where the thickness of the reflective/transmissive film 30a exceeds the range recited above, the wavelength dependence (the wavelength dispersion) of the reflectance of the reflective/transmissive film 30a increases. By setting the thickness to be the thickness recited above, the wavelength dispersion can be suppressed; and a display that is easier to view can be realized.

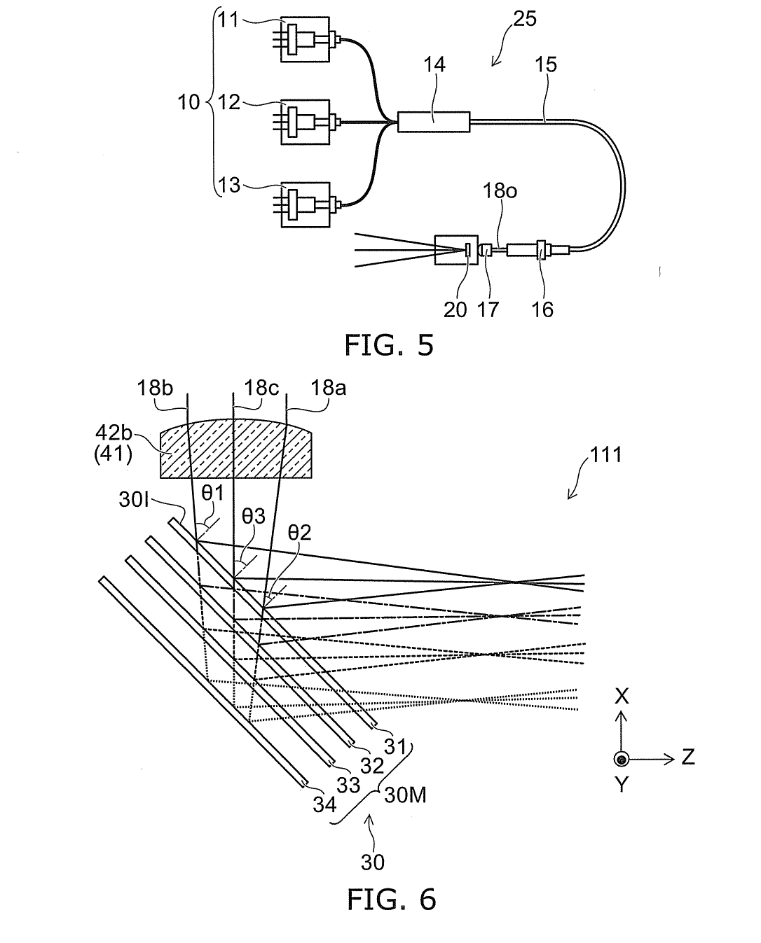

FIG. 5 is a schematic view illustrating the configuration of a portion of the display device according to the first embodiment.

As shown in FIG. 5, for example, a first laser element 11 that emits a laser beam of a red wavelength, a second laser element 12 that emits a laser beam of a green wavelength, and a third laser element 13 that emits a laser beam of a blue wavelength may be used as the laser beam source 10 of the image projection unit 25.

The image projection unit 25 may further include a combiner 14 in addition to the optical fiber 15, the fiber guide 16, and the light source-side lens 17. The laser beams emitted from the first to third laser elements 11 to 13 enter the combiner 14 and are mixed.

In the embodiment, it is favorable for the optical fiber 15 to cause the laser beam emitted from the laser beam source 10 to be incident on the scanning unit 20 while maintaining the polarization state of the laser beam. For example, a polarization-maintaining fiber (PMF) or a PANDA (Polarization-maintaining AND Absorption-reducing) fiber may be used as such an optical fiber. By using such a fiber, the effects of the bending of the optical fiber 15 on the optical characteristics can be suppressed; and a display that is easier to view can be provided.

### Second Embodiment

A display device according to the embodiment includes the image projection unit 25 and the optical unit 50. The configurations described in regard to the display device 110 are applicable to the configurations of the image projection unit 25 and the optical unit 50. In the embodiment, the operation of the image projection unit 25 is different from the operation of the image projection unit 25 of the display device 110.

FIG. 6 is a schematic plan view illustrating the configuration of a portion of the display device according to the second embodiment. As shown in FIG. 6, the second lens 41b and the reflecting unit 30 are provided in the display device 111 according to the embodiment.

In the display device 111, for example, the first scanned laser beam 18a corresponding to the first position Pa of one end of the image, the second scanned laser beam 18b corresponding to the second position Pb of one other end of the image, and the third scanned laser beam 18c corresponding to the central position Pc corresponding to the intermediate position between the second position Pb and the first position Pa are incident on the reflecting unit 30.

The first to third scanned laser beams 18a to 18c are non-parallel to each other when incident on the reflecting unit 30. Therefore, the angles (the incident angles) of the first to third scanned laser beams 18a to 18c when incident on the reflecting unit 30 are different from each other. Here, the incident angle is the angle when the normal of the incident surface 30I of the reflecting unit 30 is used as a reference.

In other words, the first to third scanned laser beams 18a to 18c are incident on the incident surface 30I at different first to third incident angles θ1 to θ3, respectively. For example, θ2<θ3<θ1.

Here, the reflective surfaces of the multiple half mirrors 30M (e.g., the major surfaces of the first to fourth reflective/transmissive films 31a to 34a) are parallel to each other and are parallel to the incident surface 30I. The incident surface 30I corresponds to the major surface of the first reflective/transmissive film 31a.

The reflectances of the reflective surfaces of the multiple half mirrors 30M (e.g., the major surfaces of the first to fourth reflective/transmissive films 31a to 34a) depend on the incident angles.

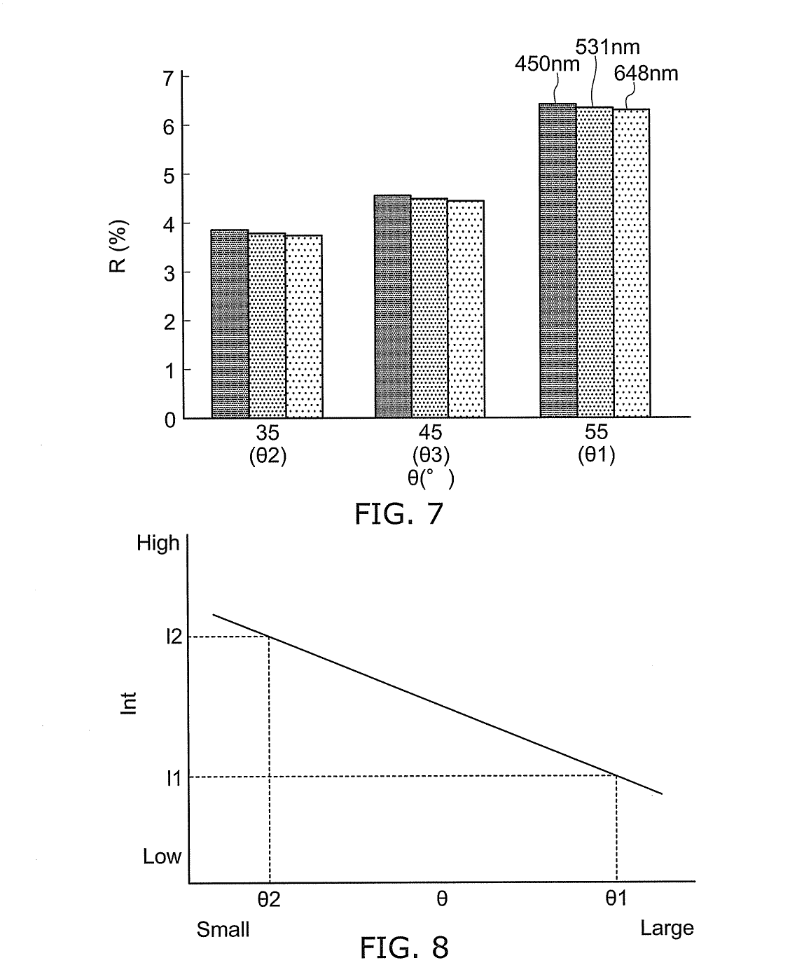

FIG. 7 is a graph illustrating characteristics of the half mirror.

FIG. 7 shows an example of the relationship between the incident angle θ of the light traveling toward the half mirror 30M and the reflectance R of the half mirror 30M. In the example, a thin film of a metal (in this example, aluminum) is used as the reflective/transmissive film 30a (the first to fourth reflective/transmissive films 31a to 34a) of the half mirror 30M. FIG. 7 shows the characteristics when the wavelength of the light is 450 nanometers (nm), 531 nm, and 648 nm.

As shown in FIG. 7, for all wavelengths, the reflectance R increases as the incident angle θ increases. For example, the reflectance R is 4% when the incident angle θ is 35 degrees; the reflectance R is 4.5% when the incident angle θ is 45 degrees; and the reflectance R is 6% when the incident angle θ is 55 degrees.

In the case where the intensity of the laser beam 18 is constant regardless of the incident angle of the scanned laser beam 18 on the reflecting unit 30, the intensity of the reflected light that is obtained changes according to the incident angle θ. For example, the image is bright at one portion of the image where the incident angle θ is large; and the image is dark at one other end of the image where the incident angle θ is small.

In the display device according to the embodiment, the intensity of the scanned laser beam 18 is controlled to compensate the relationship between the incident angle θ and the reflectance R.

FIG. 8 is a graph illustrating the operation of the display device according to the second embodiment.

In FIG. 8, the horizontal axis represents the incident angle θ when the scanned laser beam 18 is incident on the reflecting unit 30; and the vertical axis represents an intensity Int (a relative value) of the scanned laser beam 18.

In the embodiment as shown in FIG. 8, the intensity of the laser beam 18 is reduced when the incident angle θ is large; and the intensity of the laser beam 18 is increased when the incident angle θ is small. In other words, a first intensity Ii of the scanned laser beam when the scanned laser beam 18 is incident on the reflecting unit 30 at the first incident angle θ1 is lower than a second intensity 12 of the scanned laser beam 18 when the scanned laser beam 18 is incident on the reflecting unit 30 at the second incident angle θ2 that is smaller than the first incident angle θ1. For example, the intensity (the luminance) of the laser beam 18 is corrected using an approximate correction formula for the characteristics shown in FIG. 7.

Thus, in the embodiment, the intensity of the scanned laser beam 18 is modified according to the travel direction of the scanned laser beam 18. Thereby, the change of the reflectance R due to the incident angle θ is compensated; and a display that is more uniform in the screen can be provided.

There is a method in which a Maxwellian view in which the focus adjustment of the lens of the eye is unnecessary is utilized in the HMD. In the Maxwellian view, the location that can be viewed is extremely limited; and the Maxwellian view is difficult to practically view. Although there is a method to enlarge the viewing zone in which a liquid crystal panel is used as the display unit and multiple pinholes are provided, in such a case, the device is larger because an optical path having the surface area of the panel is necessary.

On the other hand, a direct retinal display device in which a laser beam is raster scanned using a MEMS mirror, etc., is effective for reducing the size. However, in such a case, the light corresponding to each of the pixels travels in a straight line; and the method for providing multiple pinholes to enlarge the viewing zone cannot be applied.

In the image projection unit 25 of the display device according to the embodiment, for example, the RGB laser beam source 10 and a MEMS mirror (the scanning unit 20) of the X-axis direction and the Y-axis direction are provided to form the image by raster scanning the laser beam emitted from the laser beam source 10. The optical unit 50 includes, for example, a mirror (the reflective mirror 43) that reflects the image of the scanned laser beam 18 from the MEMS mirror, the optical element unit 40 including a telecentric optical system (the lens unit 41) to relay the light reflected by the mirror as parallel light, and the reflecting unit 30 (the multiple half mirrors 30M) to reflect the image toward the eye 80.

The display device according to the embodiment is, for example, a Maxwellian view optical system; and the image is viewed proximally to the focal point (the point 70) directly in front of the eye 80 because the laser beam 18 that is emitted from the laser beam source 10 and scanned is light traveling in a straight line.

Because the multiple half mirrors 30M are provided in the display device 110, multiple focal points (the points 70) corresponding to the multiple half mirrors 30M can be formed. Thereby, the image can be viewed proximally to the multiple focal points (the points 70).

According to the embodiment, a compact display device having a wide viewing zone that is easy to view can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the display device such as the image projection unit, the laser beam source, the scanning unit, the optical unit, the reflecting unit, the reflective/transmissive film, the reflection suppression film, the substrate, the spacer, the optical element unit, the reflective mirror, the lens unit, the first lens, the second lens, etc., from known art; and such practice is included in the scope of the invention to the extent that similar effects are obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
an image projection unit including a laser beam source configured to emit a laser beam including image information, and a scanning unit configured to scan the laser beam; and
an optical unit including a reflecting unit including a plurality of half mirrors stacked with each other, the scanned laser beam being sequentially incident on the plurality of half mirrors, respective reflected laser beams being produced by being reflected by each of the half mirrors to pass through a plurality of mutually-different points.

2. The device according to claim 1, further comprising a holder configured to regulate a spatial disposition between the points and an eye of a user by holding the image projection unit and the optical unit.

3. The device according to claim 2, wherein a distance between the point and a pupil of the eye is not less than 0 millimeters and not more than about 10 millimeters.

4. The device according to claim 1, wherein
the reflecting unit has an incident surface, the scanned laser beam being incident on the incident surface,
the half mirrors include a first half mirror and a second half mirror, the first half mirror being disposed on a side of the incident surface of the second half mirror, and
a reflectance of the first half mirror is lower than a reflectance of the second half mirror.

5. The device according to claim 1, wherein
the reflecting unit has an incident surface, the scanned laser beam being incident on the incident surface,
the half mirrors include first to nth (n being an integer not less than 2) half mirrors,
the ith (i being an integer less n and not less than 1) half mirror is disposed on a side of the incident surface of the (i+1)th half mirror, and
a reflectance Rᵢ of the ith half mirror is lower than a reflectance Rᵢ₊₁ of the (i+1)th half mirror.

6. The device according to claim 1, wherein
the reflecting unit has an incident surface, the laser beam being incident on the incident surface,
the half mirrors include first to nth (n being an integer not less than 2) half mirrors,
the ith (i being an integer less n and not less than 1) half mirror is disposed on a side of the incident surface of the (i+1)th half mirror, and
a reflectance Rᵢ of the ith half mirror, an absorptance Aᵢ of the ith half mirror, and a reflectance Rᵢ₊₁ of the (i+1)th half mirror satisfy a relationship
Rᵢ/Aᵢ²(1−Rᵢ)²×0.8<Rᵢ₊₁<Rᵢ/Aᵢ²(1−Rᵢ)²×1.2.

7. The device according to claim 1, wherein a distance along a stacking direction of the half mirrors between a reflective surface of one of two most proximal half mirrors of the half mirrors and a reflective surface of one other of the two most proximal half mirrors of the half mirrors is not less than 1.5 mm and not more than 4.0 mm.

8. The device according to claim 1, wherein a distance along a stacking direction of the half mirrors between a reflective surface of one of two most proximal half mirrors of the half mirrors and a reflective surface of one other of the two most proximal half mirrors of the half mirrors is not less than 2.5 mm and not more than 3.5 mm.

9. The device according to claim 1, wherein the half mirrors are planes.

10. The device according to claim 1, wherein each of the half mirrors includes:
a reflective/transmissive film configured to transmit a portion of the scanned laser beam and reflect one other portion of the scanned laser beam; and
a reflection suppression film stacked with the reflective/transmissive film.

11. The device according to claim 10, wherein
each of the half mirrors further includes a substrate configured to transmit the laser beam, and
the substrate is disposed between the reflective/transmissive film and the reflection suppression film.

12. The device according to claim 10, wherein a thickness of the reflective/transmissive film is not less than 10 nanometers and not more than 200 nanometers.

13. The device according to claim 1, wherein an intensity of the scanned laser beam is modified according to a travel direction of the scanned laser beam.

14. The device according to claim 1, wherein a first intensity of the scanned laser beam when the scanned laser beam is incident on the reflecting unit at a first incident angle is lower than a second intensity of the scanned laser beam when the scanned laser beam is incident on the reflecting unit at a second incident angle smaller than the first incident angle.

15. The device according to claim 1, wherein the image projection unit further includes an optical fiber configured to cause the laser beam emitted from the laser beam source to be incident on the scanning unit while maintaining a polarization state of the laser beam.

16. The device according to claim 1, wherein a beam spread angle of the scanned laser beam when emitted from the image projection unit is not more than plus or minus 5 degrees.

17. The device according to claim 1, wherein a diameter of a spot of the laser beam when incident on the reflecting unit is not less than 100 micrometers and not more than 800 micrometers.

18. The device according to claim 1, wherein
the scanning unit is configured to scan the laser beam between a first position corresponding to one end of an image and a second position corresponding to one other end of the image, and
the optical unit further includes a lens unit configured to cause a travel direction of the laser beam scanned to the first position to be parallel to a travel direction of the laser beam scanned to the second position.

19. The device according to claim 1, wherein the reflecting unit further includes a gap unit provided between the half mirrors, a refractive index of the gap unit being lower than refractive indexes of the half mirrors.

20. The device according to claim 19, wherein the gap unit is an air layer.
